(19) United States
(12) Patent Application Publication
(10) Pub. No.: US 2008/0052421 A1
(43) Pub. Date: Feb. 28, 2008

(54) Method for use where a first and second device are connected

(75) Inventor: Richard Petrie, Guildford (GB)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/826,684

(22) Filed: Jul. 17, 2007

(30) Foreign Application Priority Data
Jul. 18, 2006 (GB) 0614258.2

(51) Int. Cl. G06F 3/00

(52) U.S. Cl. 710/8

(57) ABSTRACT

A method for use where a first and second device are connected A method comprises interacting with a first device and a second device. The first and second devices are connected together. A selection is made, based on an interaction order of said first and second devices, as to which one of said devices to be a master device.

### FIELD OF THE INVENTION

The present invention relates to a method and in particular, but not exclusively to a method of controlling the behaviour of two devices connected to each other. The present invention also relates to a device, a computer program and a system.

### BACKGROUND TO THE INVENTION

USB (Universal Serial Bus) is a technology which provides a fast, cabled data connection between a complex device (e.g. a PC) which is called the Host and a connected peripheral (e.g. a mouse, keyboard, personal organizer or the like) which is called the Device. The standard is managed by the USB Implementer's forum.

Some implementations of USB contain functionality to operate as a USB Device and support functionality such as modern functionality, PIM Personal Information Management synchronization, mass storage and printing.

The USB standard has been extended to include connections between mobile devices such as mobile phones or mobile data devices in the USB OTG (On-The-Go) supplement. This supplement allows a peripheral at either end of the connection to take a Host or Device role. The initial roles are decided by the direction of the cable connection i.e. the type of plug A or B inserted into the peripheral.

The peripheral with the USB OTG A-plug inserted is called the A-Device. The A-Device supplies power for the duration of the connection and initially takes the Host role. The peripheral with the USB OTG B-plug inserted is called the B-Device. The B-Device draws power from the A-Device and initially takes a Device role.

Two protocols are defined by the USB OTG standard:

Firstly there is the Session Request Protocol (SRP). This enables an A-Device to turn off its power supply (called VBUS—Voltage line of the USB interface). This is because it provides a mechanism for the B-Device to signal that this power supply should be re-established in order to commence a new session.

Secondly, there is Host Negotiation Protocol or HNP. This allows a B-Device to request a role as Host. The protocol works by firstly, the A-Device enabling this capability in the B-Device. After this point, whenever the A-Device suspends the bus the B-Device may use HNP to request the host role. Suspending the bus means that there is no activity on the bus including the normal USB framing indicated by SOF (Start of Frame) packets. However, the standard allows for the A-Device to take back the host role at any point.

FIG. 1 shows a state machine of a current proposal of the USB OTG working group. The following pairs of scenarios behave in a symmetric way within the state machine in FIG. 1:
User connects the cable and interacts with the A-Device→A-Device becomes host
User connects the cable and interacts with the B-Device→B-Device becomes host
User interacts with the A-Device and then connects the cable→A-Device becomes host
User interacts with the B-Device and then connects the cable→B-Device becomes host
User interacts with the B-Device while A-Device is active→A-Device remains as host
User interacts with the A-Device while the B-Device is active→B-Device remains as host

The following constraints underlie the state machine in FIG. 1:
Both devices support USB OTG including SRP and HNP
Both devices are turned on, booted up and capable of making USB connections
The A-Device will enable VBUS on an A-plug insertion events based on the ID pin only after a user interaction and before session timeout (B-plug insertion is not detected)
When unattached the A-Device powers VBUS based on a given user interaction and subsequently attempts to become the host on connection
When unattached the B-Device starts SRP polling based on a given user interaction and subsequently attempts to become the host on connection
The A-Device immediately enables HNP in the B-Device at the start of a session
When the connection is not active the A-Device turns off VBUS in order to save power
The A-Device will not attempt to take the host role while the B-Device is active as a host

There are two timeouts which are active before the cable is connected. These can also be seen in FIG. 1. The timeout for an A-Device is the length of time it applies a voltage on VBUS after a user interaction (session timeout). The timeout for a B-Device is the length of time it generates SRP requests after a user interaction (SRP timeout). These timeouts are required for symmetric behaviour and should be the same value to make this possible.

For completeness sake, a description of the arrangement of FIG. 1 follows. There are states A, B, D, E, F and G.

State A is the case where VBUS is off and the cable is unattached.

State B is VBUS on and the cable unattached.

State D is where VBUS is on, the cable is attached and the Host is the A-Device.

State E is VBUS is off and the cable is attached.

State F is VBUS on, the cable is attached and the host is the B-Device.

State G is VBUS off, SRP polling on and the cable unattached.

To go from State A to State B (arrow ab), this occurs when there is A-Device User interaction.

To go from State B to State A (arrow ba), this occurs when there is a session time out.

To go from State B to State D (arrow bd), this occurs when the cable is attached.

To go from State D to State D (arrow dd), this occurs when there is B-Device interaction.

To go from State D to State E (arrow de), this occurs when the A-Device activity is completed.

To go from State E to State D (arrow ed), this occurs when there is A-Device activity.

To go from State A to State E (arrow ae), this occurs when the cable is attached.

To go from State F to State E (arrow fe), this occurs when the B-Device completes activity.

To go from State E to State F (arrow ef), this occurs when there is B-Device user interaction. The B-Device performs SRP followed by HNP.

To go from State F to State F (arrow ff), this occurs when there is A-Device user interaction. The A-Device realizes that B-device is currently host and makes not attempt to take control.

To go from State G to State F (arrow gf), this occurs when the cable is attached. The B-Device performs SRP followed by HNP.

To go from State G to State A (arrow ga), this occurs when there is a SRP Timeout.

To go from State A to State G (arrow ag), this occurs when there is B-Device user interaction.

One problem with the arrangement of FIG. 1 is that it does not cater for cases where the user interacts with both devices before attaching the cable.

FIG. 1 additionally describes the case where the user interacts first with one device and then with a second device. In this case there is asymmetry.

In the following scenarios the behaviour is asymmetric from an end user perspective:
User interacts with the A-Device, then the B-Device and then connects the cable→A-Device becomes host
User interacts with the B-Device, then the A-Device and then connects the cable→A-Device becomes host

The user expects that the last device interacted with before attaching the cable becomes the host.

The arrangement of FIG. 2 will now be described. This shows states A to F. The differences between the arrangement of FIG. 1 and that of FIG. 2 only will be described.

There is a new state, State C which is when VBUS is on, the SRP polling is on and the cable is unattached. The SRP polling is repeated performed by the B-Device in this state and in State G until SRP equals SRP timeout which is equal to the A-Device session time out.

The new transitions are:

To go from State B to State C (arrow bc), this occurs when there is B-Device user interaction.

To go from State C to State B (arrow cb), this occurs when there is SRP timeout. This SRP timeout will occur when the A-Device user interaction is followed by a B-Device user interaction since the SRP and session timeout periods are equal.

To go from State C to State D (arrow cd), this occurs when the cable is attached. The B-Device stops the SRP because VBUS is asserted. HNP does not succeed because the A-device believes it should be host.

To go from State G to State C (arrow gc), this occurs when there is A-Device user interaction.

To go from State C to State G (arrow cg), this occurs when there is session timeout. This session time out will occur when A-Device user interaction is followed by B-Device user interaction since the SRP and session timeout periods are equal.

### SUMMARY OF THE INVENTION

It is an aim of at least some embodiments of the invention to address or at least mitigate one or more of the above described problems.

Various aspects of the invention can be seen from the appended claims.

For good usability of USB OTG, the end user is preferably unaware of the underlying technology. Preferably the host role should be taken by the device which the device is currently using. Preferably the user is also unaware of the direction of the cable. Embodiments of the present invention may achieve this.

### BRIEF DESCRIPTION OF DRAWINGS

For a better understanding of the present invention and as to how the same may be carried into effect, reference will now be made by way of example only to the accompanying drawings in which:

FIG. 1 shows a state machine which provides a solution to USB OTG symmetry;

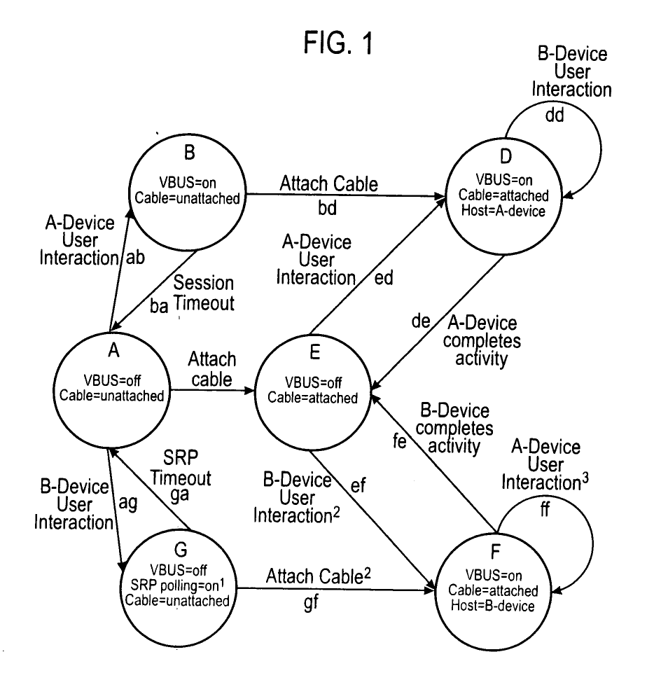

FIG. 2 shows the asymmetry which is introduced when the end user uses both devices which are to be connected together via a USB connection;

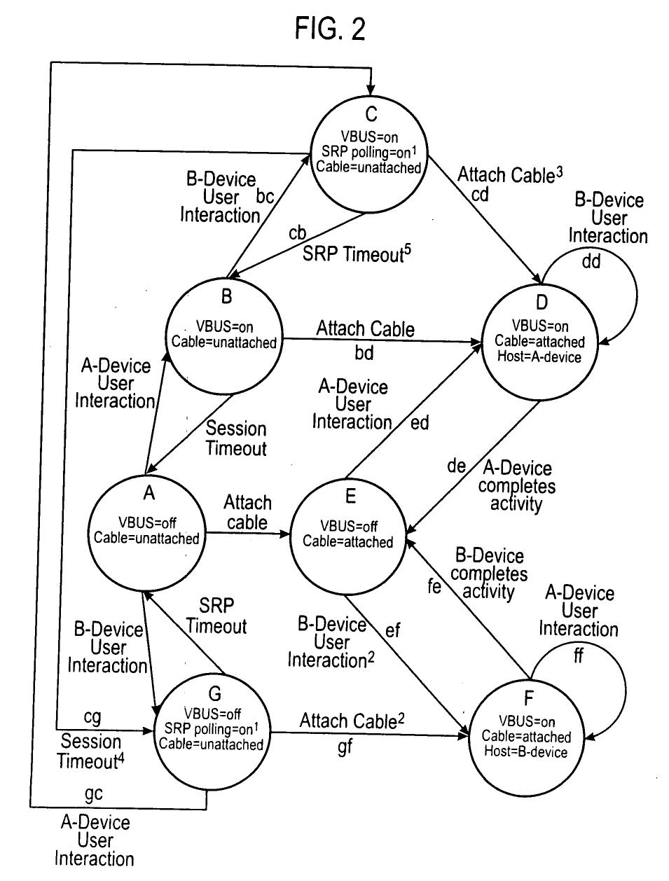

FIG. 3 shows the a symmetric solution to interaction with both devices, in accordance with an embodiment of the invention;

FIG. 4 shows a flow chart of the steps performed by the A-Device in accordance with an embodiment of the invention;

FIG. 5 shows a flow chart of the steps performed by the B-Device in accordance with an embodiment of the invention; and

FIG. 6 shows two devices connected together.

### DETAILED DESCRIPTION OF EMBODIMENTS OF THE INVENTION

Embodiments of the invention may provide a mechanism where the behaviour of two connected OTG devices is symmetrical from the end user perspective in every case. This may address the problem above where two devices display asymmetric behaviour before they are connected.

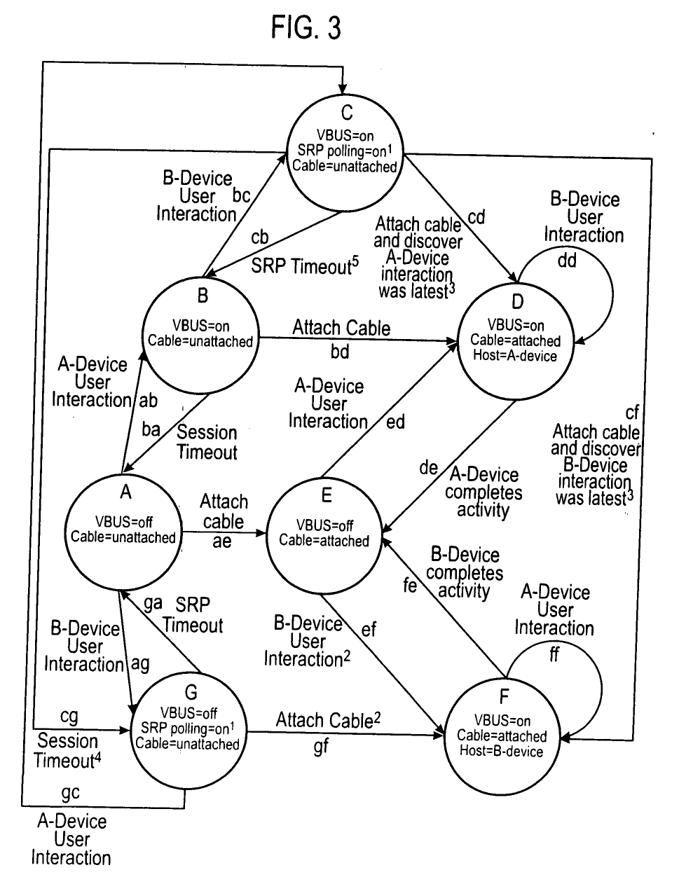

FIG. 3 shows the solution in operation. The problem asymmetric cases described above are now symmetric:
User interacts with the A-Device, then the B-Device and then connects the cable→B-Device becomes host
User interacts with the B-Device, then the A-Device and then connects the cable→A-Device becomes host

The last used device now becomes the host. Alternatively, it would be possible; using the same mechanism, to make the first used device the host but the expression defined in FIG. 3 may in some circumstances makes more sense to the end user.

Embodiments of the invention uses an extensions of the standard USB protocols to share the values of the session timeout and SRP timeout counters so that these can be compared. The counter which has been running for the shortest time indicates the host. That which has been running the longest indicates the device. These two values allow the A-Device to decide on who should become host.

Each OTG peripheral has a timeout counter. This is referred to as the session timeout when the peripheral becomes the A-Device and SRP timeout when the peripheral becomes a B-Device. On user interaction this counters is set to a common specification value fixed for all OTG peripherals. The counter counts down in discrete steps each lasting a fixed period of time until it reaches zero. A host flag will also be set indicating that in the case of the peripheral becoming the B-Device it will attempt to become the host.

With no cable attached or a B-plug attached the device will generate SRP all of the time its counter is >0. If an A-plug is attached and the timeout is >0 then SRP will cease and VBUS will be asserted until the timeout=0.

The diagram shown in FIG. 3 shows states A-G.

State A is the case with VBUS off and the cable is unattached.

State B is VBUS on and the cable unattached.

State C is VBUS on, the SRP polling is on and the cable is unattached. The B-Device repeatedly performs SRP until SRP timeout which is equal to the A-Device session timeout

State D is where VBUS is on, the cable is attached and the Host is the A-Device.

State E is VBUS is off and the cable is attached.

State F is VBUS on, the cable is attached and the host is the B-Device.

State G is VBUS off, SRP polling on and the cable unattached.

To go from State A to State B (arrow ab), this occurs when there is A-Device User interaction.

To go from State B to State A (arrow ba), this occurs when there is a session time out.

To go from State B to State C (arrow bc), this occurs when there is B-Device user interaction.

To go from State C to State B (arrow cb), this occurs when there is SRP timeout. This SRP timeout will occur when the B-Device user interaction is followed by A-Device user interaction since the SRP and session timeout periods are equal.

To go from State C to State D (arrow cd), this occurs when the cable is attached and it is determined that the A-Device interaction was the latest. On connection, the devices compare time out values to determine which device has the latest user interaction.

To go from State B to State D (arrow bd), this occurs when the cable is attached.

To go from State D to State D (arrow dd), this occurs when there is B-Device interaction.

To go from State D to State E (arrow de), this occurs when the A-Device activity is completed.

To go from State E to State D (arrow ed), this occurs when there is A-Device activity.

To go from State A to State E (arrow ae), this occurs when the cable is attached.

To go from State F to State E (arrow fe), this occurs when the B-Device completes activity.

To go from State E to State F(arrow ef), this occurs when there is B-Device user interaction. The B-Device performs SRP followed by HNP

To go from State F to State F (arrow ff), this occurs when there is A-Device user interaction.

To go from State F to State C (arrow fc), this occurs when the cable is attached and it is discovered that the B-Device interaction was the latest. On connection, the devices compare timeout values to determine which device has the latest user interaction.

To go from State G to State F (arrow gf), this occurs when the cable is attached. The B-Device performs SRP followed by HNP.

To go from State G to State A (arrow ga), this occurs when there is a SRP Timeout.

To go from State A to State G (arrow ag), this occurs when there is B-Device user interaction.

To go from State G to State C (arrow gc), this occurs when there is A-Device user interaction.

To go from State C to State G (arrow cg), this occurs when there is session timeout. This session time out will occur when A-Device user interaction is followed by B-Device user interaction since the SRP and session timeout periods are equal.

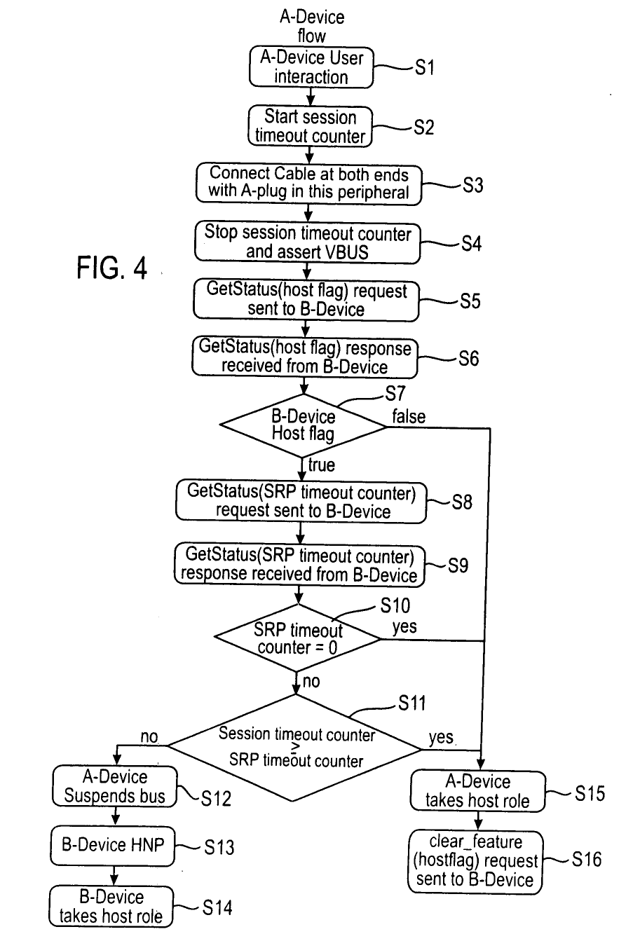

FIG. 4 shows an implementation for the peripheral which becomes the A-Device. The user interacts with this device in step S1.

This causes the session timeout counter to be started in step S2.

The cable is connected at both ends with the A-plug being inserted into this peripheral or device. This occurs in step S3.

The insertion of the A-plug into this particular device causes the session timeout counter to be stopped and for VBUS to be asserted in step S4.

The A-Device will then request the value of the host flag from the B-Device using a GetStatus request which is sent from the current device to the device that it will be connected to (the B-Device). This occurs in step S5.

In step S6, the B-Device returns, that is sends, the GetStatus response, ie the value of the Host Flag at the B-Device. This value is received at the A-Device.

In step S7, the A-Device checks the value of the B-Device host flag.

If the B-Device host flag is set to false the B-Device has no intention of becoming the host and therefore the A-Device will assume this role and the next step will be S15. In step S15, the A-Device takes host role.

In step S16, which follows step S15, the A-Device sends to the B-Device a clear_feature request. This is to request the B-Device to clear its host flag.

If, on the other hand, the host flag is true the A-Device will then request the value of the SRP timeout counter in step S8 by sending a GetStatus request which effectively requests the value of the SRP timer. This is sent to the B-Device.

In step S9, the A-Device receives a response from the B-Device which provides the value of the SRP timeout counter.

If it is determined in step S10 that the SRP timeout timer has reached zero, the next step will be step S15 where the A-Device becomes the host. This is as previously described. Step S16 will follow step S15.

If in step S10, it is determined that the SRP timer is not zero, the next step is step S11. In step S11, it is determined if the A-Device's session timeout timer has a larger value than the B-Device's SRP timeout timer. If this is determined to be the case, this means that the A-Device was used last and the next step will be step S11 followed by step S16. The A-Device can then take the host role and clear the B-Device's host flag so that the B-Device does not attempt to become the host later.

If there is a contention i.e. the session timeout timer and the SRP timeout timer have the same non-zero value then the A-Device will take precedence and become host and again the next steps will be steps S15 and S16.

If it is determined in step S11 that the SRP timeout timer is larger than the session timeout timer then the B-Device was used last. In this case, the next step is step S12 where the A-Device yields by suspending the bus.

In step S13, the B-Device carries out HNP in order to take the host role in step S14.

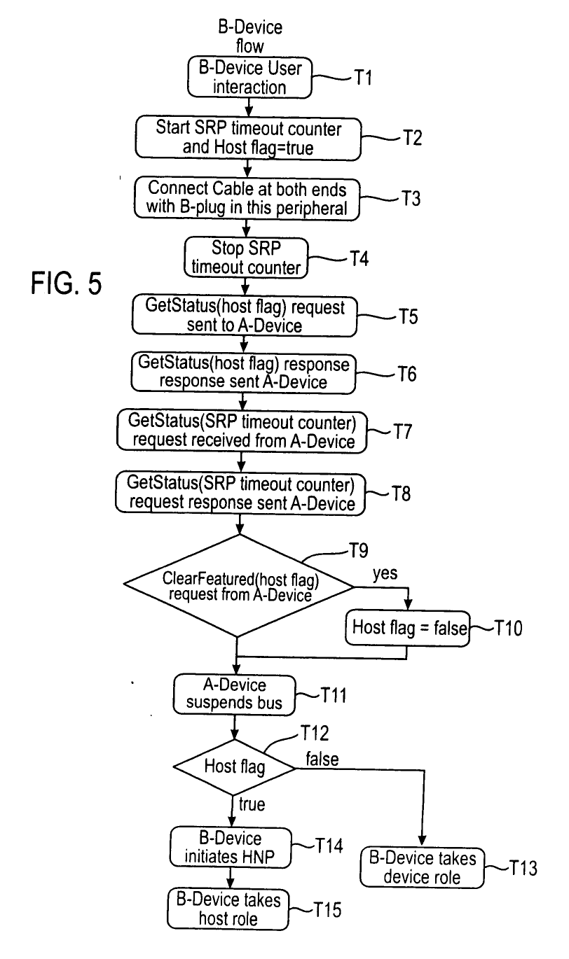

FIG. 5 shows an implementation flow diagram for a peripheral which becomes the B-Device.

In step T1, the user interacts with this device.

This causes, in step T2, the SRP timeout counter to be started and for the host flag to be set. The host flag indicates that the B-Device has the intention to become host when it next gets the opportunity.

In step T3, the cable is connected at both ends with the B-plug being inserted into this peripheral.

This causes, in step T4, the SRP timeout counter to be stopped. It should also be noted that, since VBUS has been asserted by the A-Device, the B-Device will not attempt SRP even though its host flag is set.

The B-Device receives, in step T5, a GetStatus request from the A-Device for the host flag value of the B-Device.

The value of the B-Device host flag is provided in a response to the A-Device, in step T6.

The B-device then receives a GetStatus request from the A-Device for the SRP timeout timer value in step T7.

In step T8, the value of the SRP timeout timer is provided by the B-Device to the A-Device.

If the B-Device receives in step T9 a ClearFeature request from the A-Device to reset the host flag, the host flag in the B-Device is set to false in step T10.

The B-Device detects that the A-Device has suspended the USB bus i.e. VBUS is asserted but there is no data activity including SOF. This is done in step T11.

If it is determined in step T12 that the host flag is set to true, then the B-Device will initiate HNP in step T14 and in step T15 takes the host role.

If it is determined in step T12 that the host flag is reset, ie has the false value, it will not attempt HNP and therefore takes the device role in step T13.

In order to roll out this functionality the B-Device may need to indicate to the A-Device that it has support for this feature. This could be implemented via a USB descriptor, which is used to describe support in the USB device. Currently there is a descriptor to indicate HNP support. This could be extended to include support for this feature. The information can be provided via any other signalling method.

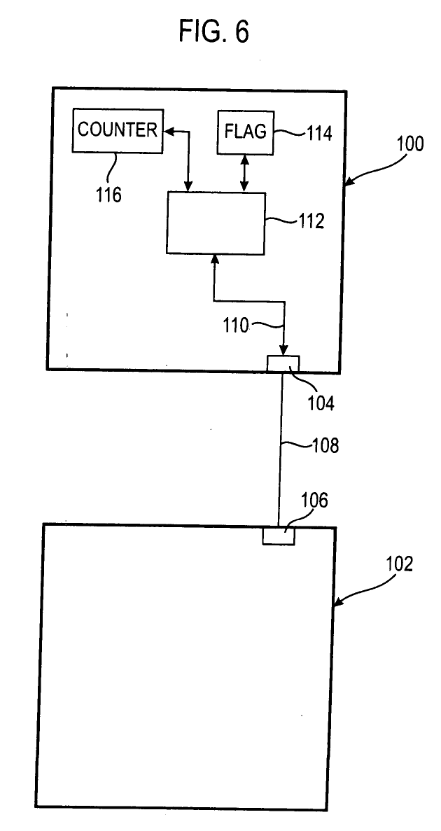

Reference is made to FIG. 6 which shows two devices 100 and 102. One or both of these devices has the capability of being an A-Device. It should be appreciated that a device which is an A-Device is one which receives the “A” plug of a USB cable. Likewise one or both of the devices has the capability of being a B-Device. Likewise a device which is a B-Device is the one which receives the “B” plug of a USB cable. One of the devices will be the A-Device and the other will be the B-Device.

The devices 100 and 102 are connected together via a cable 108. Each device has respective socket or the like 104 and 106 which allows respective connections to each end of the cable.

The structure of only the first device 100 is shown. It should be appreciated that the second device 102 may have a similar structure.

The first device comprises a counter 116. This counter can be implemented in any suitable form. It can be a count down timer, a count up timer, a clock or any other suitable circuitry which is able to provide information indicative about how long ago a user interacted with that device. The counter can be implemented in hardware, software or a combination thereof.

The second device also has memory 114 for storing the status of the flag. The memory can take any suitable form such as a latch, a register, a specific address in a memory or the like.

A processor 112 is provided. This is arranged to provide control. It receives the output of the counter 116, the flag memory and is arranged to be connected to the socket 110. The processor is arranged to be able to start the counter 116 when the controller determines that there is interaction between the user and the device. The controller will therefore output a control signal to the counter. The user interaction can comprise the actuation of a key or button, the switching on of the device, movement of the device or any other such indication. In some embodiments of the invention, the interaction can comprise the plugging of the USB cable into the socket.

The controller is able to read the value of the host flag when required and also to write a new value to the host flag memory 114.

The controller 112 is able to formulate messages or requests for information to be sent to the other device 102 via the cable 108. The controller is also able to formulate responses in response to requests received from the other device 102.

The controller 112 is thus able to control the device to provide the method set out in FIG. 4 in the event that the device is an A-Device and method set out in FIG. 5 in the event that the device is a B-Device.

It should be appreciated that the controller may be implemented in hardware, software or a combination thereof.

It should be appreciated that at least some of the steps shown in FIGS. 4 and 5 can be implemented by a computer program. Embodiments of the invention thus include computer programs, computer programs on a program carrying media or computer programs loaded in a device.

Embodiments of the invention may provide symmetry in all cases.

Devices to which embodiments of the invention can be applied can take any suitable form. The list below provides some examples of possible devices. It should be appreciated that the two devices which are connected together may be the same or different:

Mobile telephone; camera; MP3 player; picture frame; personal digital assistant (PDA); portable computer; music player; communication device; and printer.

In the example described, the connection is between two devices. It is possible that embodiments of the invention can be used with three or more connected devices.

Embodiments of the invention have been described in the context of a USB environment. It should be appreciated that embodiments of the invention may be used in non USB environments where a decision needs to be made as to which device is to be a master device or the device in control. It should be appreciated that alternative embodiments of the invention may have a wireless connection between the devices instead of a cable connection.

1. A method, comprising:
interacting with a first device and a second device;
connecting said first and second device together; and
selecting, based on an interaction order of said first and second devices, one of said devices to be a master device.

2. A methods comprising:
determining when a user interacted with a first device;
determining when a user interacted with a second device; and
selecting, based on determined information and requested information, one of said first and second devices to be a master device, based on an interaction order of said first and second devices.

3. A method, comprising:
determining information at a first device as to when a user interacted with said first device;
requesting information from a second device as to when a user interacted with said second device; and
selecting, based on said determined information and said requested information, one of said first and second devices to be a master device, based on an interaction order of said first and second devices.

4. A method as claimed in claim 1, further comprising selecting the one of the first and second devices which the user last interacted with to be said master device.

5. A method as claimed in claim 1, further comprising selecting the one of the first and second devices which the user first interacted with to be said master device.

6. A method as claimed in claim 2, further comprising connecting said first and second device via a cable.

7. A method as claimed in claim 2, wherein said first and second devices comprise respective USB ports.

8. A method as claimed in claim 2, comprising communication between said first and second devices in accordance with a USB standard.

9. A method as claimed in claim 6, wherein one of said first and second devices comprises an A-Device and another of said devices comprises a B-Device.

10. A method as claimed in claim 9, wherein said selecting is carried out by the A-Device.

11. A method as claimed in claim 9, further comprising selecting said A-Device to be a master if no selection can be made on the basis of the selection order.

12. A method as claimed in claim 8, wherein said master device comprises a host device.

13. A method as claimed in claim 1, further comprising the supplying of power from said master device to said other device.

14. A method as claimed in claim 1, further comprising determining when a user interacts with said first and second devices respectively.

15. A method as claimed in claim 2, further comprising determining when a user interacts with said first and second devices respectively by initiating respective time out operations.

16. A method as claimed in claim 15, wherein when a user interacts with a respective device, the time out operation has an initial value which is the same for both said first and second devices.

17. A method as claimed in claim 15, wherein said respective time out operations have the same duration.

18. A method as claimed in claim 15, wherein one of said first and second devices comprises an A-Device and another of said devices comprises a B-Device, wherein said time out operation comprises a session time out for said A-Device.

19. A method as claimed in claim 15, wherein one of said first and second devices comprises an A-Device, and another of said devices comprises a B-Device, wherein said time out operation is a SRP timeout if said device is the B-Device or if no cable is attached.

20. A method as claimed in claim 2, further comprising comparing information defining when a user interacted with said devices so that one of said devices can be selected to be a master device based on the interaction order.

21. A method as claimed in claim 2, further comprising setting an indicator in said master device indicative that said device is a master device.

22. A method as claimed in claim 2, further comprising setting an indicator in the device which is not the master device, indicative that said device is not a master device.

23. A method as claimed in claim 21, wherein said indicator comprises a flag.

24. A method as claimed in claim 21, comprising requesting from at least one of said first and second devices information about said indicator from the other of said first and second devices.

25. A method as claimed in claim 21, comprising sending from at least one of the first and second devices information about said indicator to the other of said first and second devices.

26. A method as claimed in claim 15, further comprising determining that a cable has been attached to a device and stopping said timeout operation in that device.

27. A method as claimed in claim 1, further comprising determining that a cable has attached to a device to causing said device to assert a voltage.

28. A method as claimed in claim 27, wherein said asserted voltage comprises a VBUS signal.

29. A device, comprising:
a connecting unit configured to connect the device to another device;
an interaction unit configured to permit a user to interact with said device;
a processor unit configured to receive information from another device via said connecting means, said information relating to when a user interacted with said another device and for determining if said device is to be a master device based on said information and when said user interacted with said device.

30. A device as claimed in claim 29, wherein said device comprises an A-Device.

31. A device, comprising:
a connecting unit configured to connect the device to another device;
an interaction unit configured to permit user to interact with said device;
a sending unit configured to send information about when said user interacted with said device to a further device; and
a receiving unit configured to receive information from said further device as to whether or not said device is to be a master device.

32. A device as claimed in claim 31, wherein said device comprises a B-Device.

33. A device as claimed in claim 29, further comprising a timing unit configured to count time intervals.

34. A device as claimed in claim 33, wherein said timing unit is configured to start when a user interacts with said device via said interaction unit.

35. A device as claimed in claim 29, wherein said connection unit comprises a plug arranged to receive a cable.

36. A device as claimed in claim 35, wherein a determining unit is configured to determine that a cable has been plugged into said plug.

37. A device as claimed in claim 36, further comprising a timing unit configured to count time intervals, wherein said timing unit is further configured such that it is stopped when a cable is plugged into said plug.

38. A device as claimed in claim 28, further comprising a memory configured to store an indication as to whether or not said device is a master device.

39. A device as claimed in claim 28, wherein said device is configured to operate in accordance with the USB standard.

40. A device comprising:
a socket for connecting the device to another device; and
a processor arranged to determine that a user has interacted with said device and to process information received from another device and to determine if said device is to be a master device based on said information.

41. A device, comprising:
a socket for allowing said device to be connected to another device; and
a processor configured to generate a message indicating when a user interacted with said device and to cause the message to be sent to a further device, said processor configured to receive information from said further device as to whether or not said device is to be a master device

42. A computer program embodied on a computer-readable medium, comprising program code configured to control a processor to:
cause a first device to determine information as to when a user interacted with said device;
cause said first device to request information from a second device as to when a user interacted with said second device; and
select, based on said determined information and said requested information, one of said first and second devices to be a master device.

43. A system, comprising:
a first and a second device, each of said first and second devices have means for permitting a user to interact with each other, said first and second devices comprising means for connecting together said first and second devices, said system further comprising
a selecting unit configured to select, based on an interaction order of said first and second devices, one of said devices to be a master device.

44. A system, comprising:
means for determining when a user interacted with a first device;
means for determining when a user interacted with a second device; and
means for selecting, based on said determined information and said requested information, one of said first and second devices to be a master device, based on an interaction order of said first and second devices.

45. A system comprising:
means for determining information at a first device as to when a user interacted with said first device;
means for requesting information from a second device as to when a user interacted with said second device; and
means for selecting, based on said determined information and said requested information, one of said first and second devices to be a master device, based on an interaction order of said first and second devices.
